(19) United States
(12) Patent Application Publication
(10) Pub. No.: US 2002/0052735 A1
(43) Pub. Date: May 2, 2002

(54) Sound reproduction apparatus and method with variable-speed fast forward/reverse

(76) Inventors: Soichi Nagano, Tokyo (JP); Kenji Miyashita, Tokyo (JP); Takahisa Aoyagi, Tokyo (JP)

Correspondence Address: BIRCH STEWART KOLASCH & BIRCH, PO BOX 747, FALLS CHURCH, VA, 22040-0747, US

(21) Appl. No.: 10/024,150

(22) Filed: Dec. 21, 2001

(30) Foreign Application Priority Data
Jul. 17, 2000 (JP) 2001-217016

(51) Int. Cl. G10L 11/04

(52) U.S. Cl. 704/207

(57) ABSTRACT

A sound reproduction apparatus includes a digital memory and a specified reproduced frame number decoding section. The digital memory stores audio data such as MP3 data. The specified reproduced frame number decoding section decodes specified frames and outputs reproduced sound. The sound reproduction apparatus further includes a reproduced frame number setting section and a skipped frame number setting section that contain a reproduced frame number and a skipped frame number, respectively. When a fast forward/reverse instruction section instructs the fast forward, the specified reproduced frame number decoding section decodes only the reproduced frames and outputs reproduced sound at a higher speed than a normal speed. The sound reproduction apparatus can freely change the reproduced frame number and skipped frame number, and hence can vary the speed of the fast forward. Thus, it can reach a desired reproduction position in a shorter time, and has better operability than a conventional sound reproduction apparatus.

### BACKGROUND OF THE INVENTION

1. Field of the Invention

The present invention relates to a sound reproduction apparatus for reproducing audio data, and particularly to a sound reproduction apparatus and method capable of fast forward and fast reverse during reproduction at a high speed.

2. Description of Related Art

FIG. 9 is a block diagram showing a configuration of a conventional sound reproduction apparatus. In FIG. 9, the reference numeral 101 designates a digital memory, 102 designates a specified reproduced frame number decoding section, 103 designates a D/A converter and 104 designates a fast forward/reverse instruction section. The sound reproduction apparatus reproduces audio data such as compressed musical data like MP3 (MPEG-1 Layer 3) at a normal rate. Besides, it has a function of enabling fast forward (CUE) and fast reverse (REVIEW) during the sound reproduction.

Next, the operation of the conventional sound reproduction apparatus will be described.

In the normal replay mode, the specified reproduced frame number decoding section 102 decodes all the frames of the compressed musical data that are stored in the digital memory 101 except when the fast forward/reverse instruction section 104 specifies the frames. The decoded data is output as audio sounds via the D/A converter 103.

On the other hand, when the fast forward/reverse instruction section 104 instructs it to fast forward or fast reverse, the specified reproduced frame number decoding section 102 decodes a specified number of frames of the compressed musical data stored in digital memory 101. The decoded data is output as audio sounds via the D/A converter 103.

Thus, it decodes the predetermined number of frames, followed by skipping a predetermined number of frames, and followed by decoding the next predetermined number of frames. Thus controlling the decoding and skipping of the frames in the digital memory 101 can implement the fast forward or fast reverse.

Here, a frame structure of the compressed musical data stored in the digital memory 101 will be described with reference to FIG. 10. FIG. 10(a) illustrates a frame structure including the compressed musical data.

In FIG. 10, the reference numeral 201 designates a sync header, 202 designates data corresponding to one frame, and 203 designates a region including compressed musical data which is linked on a frame by frame basis. All the frames including the compressed musical data are stored into the digital memory 101.

FIG. 10(b) illustrates a skipping operation in a double-speed fast forward (CUE). Section A is reproduced frames (two frames for each section A), and section B is skipped frames (two frames for each section B).

In the double-speed fast forward, the specified reproduced frame number decoding section 102 replays only the reproduced frames A of FIG. 10(a) as a linked data stream as illustrated in FIG. 10(b). Thus reproducing only half the actual compressed musical data can implement the double-speed fast forward.

With the foregoing configuration, the conventional sound reproduction apparatus has a problem of taking a long time to reach a desired reproduction position by the fast forward or reverse. This is because the number of consecutive frames to be reproduced (decoded) and that to be skipped are fixed in the fast forward (CUE) or fast reverse (REVIEW) of the compressed musical data composed of blocks, each consisting of the sync header followed by frame data. Thus, the numbers of the frames to be reproduced and skipped cannot be varied, thereby limiting the fast reproduction rate.

### SUMMARY OF THE INVENTION

The present invention is implemented to solve the foregoing problem. It is therefore an object of the present invention to provide a sound reproduction apparatus and method capable of easily varying the speed of the fast forward and rewind, thereby making it possible to reach a desired reproduction position in a short time and to improve operability.

According to a first aspect of the present invention, there is provided a sound reproduction apparatus for reproducing audio data consisting of a plurality of frames, the sound reproduction apparatus comprising: an operating section for detecting a key operation for fast forward/reverse and issues an instruction of the fast forward/reverse; a specified reproduced frame number decoding section for decoding a specified reproduced frame number of frames and for skipping a specified skipped frame number of frames in the audio data during the fast forward/reverse; a reproduced frame number setting section for providing the specified reproduced frame number decoding section with the specified reproduced frame number for the fast forward/reverse; and a skipped frame number setting section for providing the specified reproduced frame number decoding section with the specified skipped frame number for the fast forward/reverse.

The sound reproduction apparatus may further comprises a rate change decision section for detecting depression duration of a key of the operating section, and for increasing the rate of the fast forward/reverse by varying at least one of the specified reproduced frame number in the reproduced frame number setting section and the specified skipped frame number in the skipped frame number setting section to values that will accelerate the fast forward/reverse.

The sound reproduction apparatus may further comprise a sampling frequency detecting section for detecting a sampling frequency of the audio data in a sync header included in each frame of the audio data, and for varying, when the sampling frequency is changed during the fast forward/reverse, at least one of the specified reproduced frame number and the specified skipped frame number to a predetermined value in response to the sampling frequencies before and after the change of the sampling frequency.

The sound reproduction apparatus may further comprise a variable frame number specifying section for varying the specified reproduced frame number to be set in the reproduced frame number setting section and the specified skipped frame number to be set in the skipped frame number setting section for the fast forward/reverse individually or in combination, when depression duration of a key in the operating section is longer than normal duration to further increase the speed of the fast forward/reverse.

According to a second aspect of the present invention, there is provided a sound reproduction method of reproducing audio data consisting of a plurality of frames, the sound reproduction method comprising the steps of: detecting a key operation for fast forward/reverse; decoding a specified reproduced frame number of frames and skipping a specified skipped number of frames; and changing at least one of the specified reproduced frame number and the specified skipped frame number to desired values for the fast forward/reverse.

Here, the sound reproduction method may further comprise the steps of: detecting depression duration of a key for the fast forward/reverse; and increasing the rate of the fast forward/reverse by varying at least one of the specified reproduced frame number and the specified skipped frame number to a value that will accelerate the fast forward/reverse.

The sound reproduction method may further comprise the steps of: detecting a sampling frequency of the audio data in a sync header included in each frame of the audio data; and varying, when the sampling frequency is changed during the fast forward/reverse, at least one of the specified reproduced frame number and the specified skipped frame number to a predetermined value in response to the sampling frequencies before and after the change of the sampling frequency.

The sound reproduction method may further comprise the step of varying, when depression duration of a key in an operating section is longer than normal duration in the fast forward/reverse mode, the specified reproduced frame number and the specified skipped frame number individually or in combination to such values that will increase the rate of the fast forward/reverse.

### BRIEF DESCRIPTION OF THE DRAWINGS

FIG. 1 is a block diagram showing a configuration of an embodiment 1 of a sound reproduction apparatus in accordance with the present invention;

FIGS. 2A and 2B are schematic diagrams each showing a frame structure of musical data for illustrating variable-speed fast forward;

FIG. 3 is a block diagram showing a configuration of an embodiment 2 of the sound reproduction apparatus in accordance with the present invention;

FIG. 4 is a flowchart illustrating a variable-speed fast forward/reverse operation in the embodiment 2;

FIG. 5 is a block diagram showing a configuration of an embodiment 3 of the sound reproduction apparatus in accordance with the present invention;

FIG. 6 is a schematic diagram illustrating a content of an MP3 audio frame;

FIG. 7 is a block diagram showing a configuration of an embodiment 4 of the sound reproduction apparatus in accordance with the present invention;

FIG. 8 is a schematic diagram illustrating frame structures in operations of changing reproduced and skipped frames;

FIG. 9 is a block diagram showing a configuration of a conventional sound reproduction apparatus; and

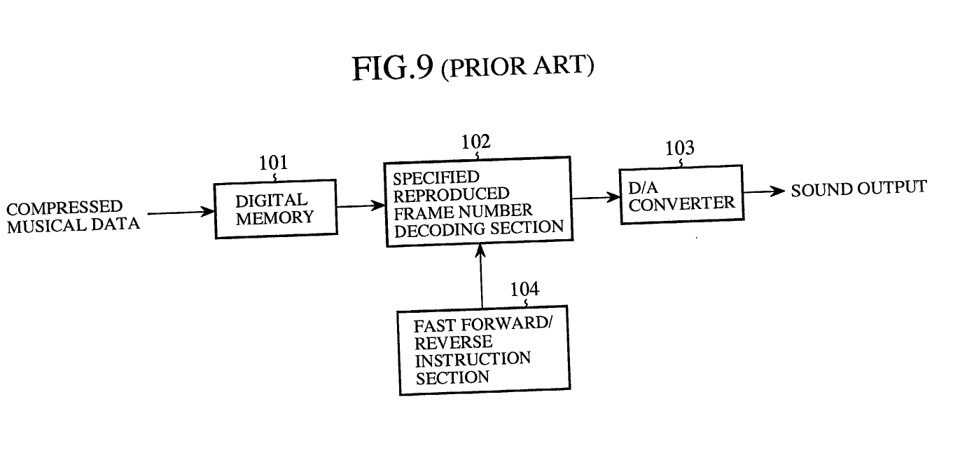

FIG. 10 is a schematic diagram illustrating a frame structure of musical data for illustrating conventional fast forward.

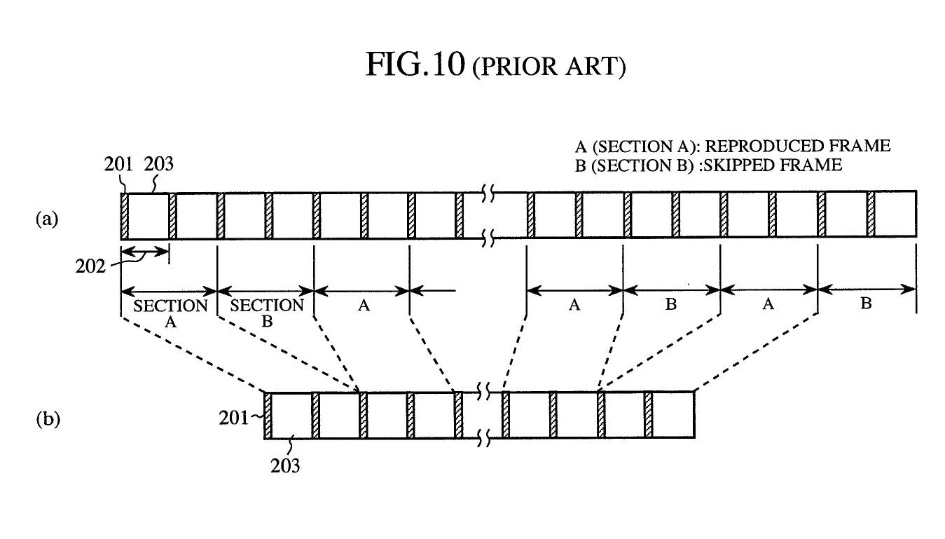

### DETAILED DESCRIPTION OF THE PREFERRED EMBODIMENTS

The invention will now be described with reference to the accompanying drawings. The audio data reproduced in the following embodiments are assumed to be compressed musical data according to MP3 (MPEG-1 Layer 3), and configurations for carrying out the fast forward (CUE) and fast reverse (REVIEW) of the musical data will be described.

### EMBODIMENT 1

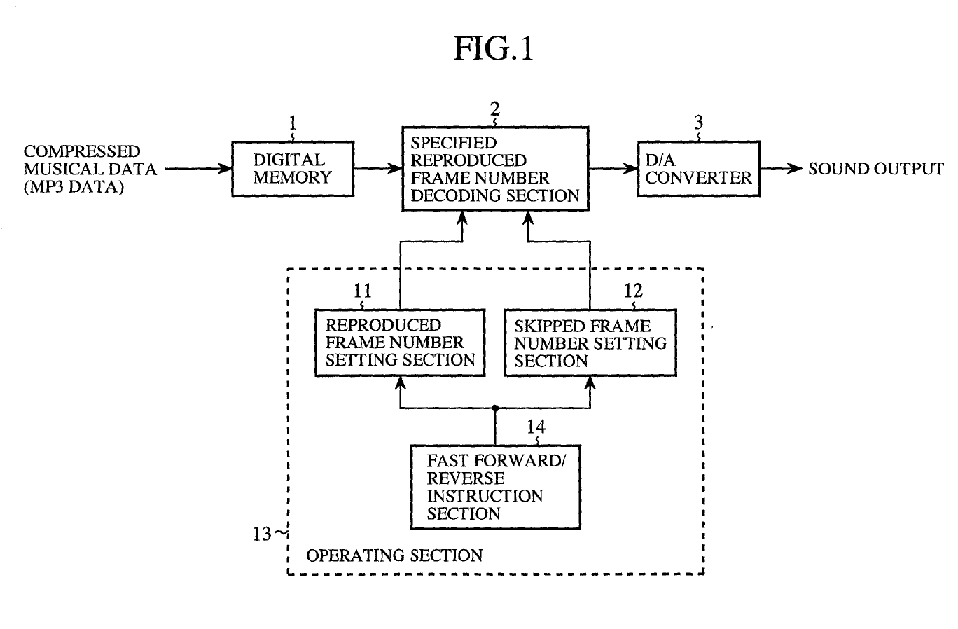

FIG. 1 is a block diagram showing a configuration of an embodiment 1 of the sound reproduction apparatus in accordance with the present invention. In this figure, the reference numeral 1 designates a digital memory, 2 designates a specified reproduced frame number decoding section and 3 designates a D/A converter. The reference numeral 11 designates a reproduced frame number setting section, 12 designates a skipped frame number setting section, and 14 designates a fast forward/reverse instruction section. These sections 11, 12 and 14 constitutes an operating section 13.

Next, the operation of the present embodiment 1 will be described.

Since the normal reproduction mode is the same as that of the conventional device, only the fast forward or fast reverse mode the fast forward/reverse instruction section 14 commands will be described.

In this case, according to the reproduced frame number and skipped frame number, which are set by the reproduced frame number setting section 11 and the skipped frame number setting section 12, respectively, the specified reproduced frame number decoding section 2 reads the audio data from the digital memory 1 by the reproduced frame number, and replays the data.

Subsequently, the specified reproduced frame number decoding section 2 skips reading data from the digital memory 1 by the skipped frame number. Then, it reads the next audio data from the digital memory 1 by the reproduced frame number, and replays the audio data.

The control can implement the fast forward or fast reverse by varying the reproduced frame number and skipped frame number through the reproduced frame number setting section 11 and skipped frame number setting section 12.

The reproduced frame number and skipped frame number, which are set in the reproduced frame number setting section 11 and skipped frame number setting section 12, can be varied to desired values by external operation.

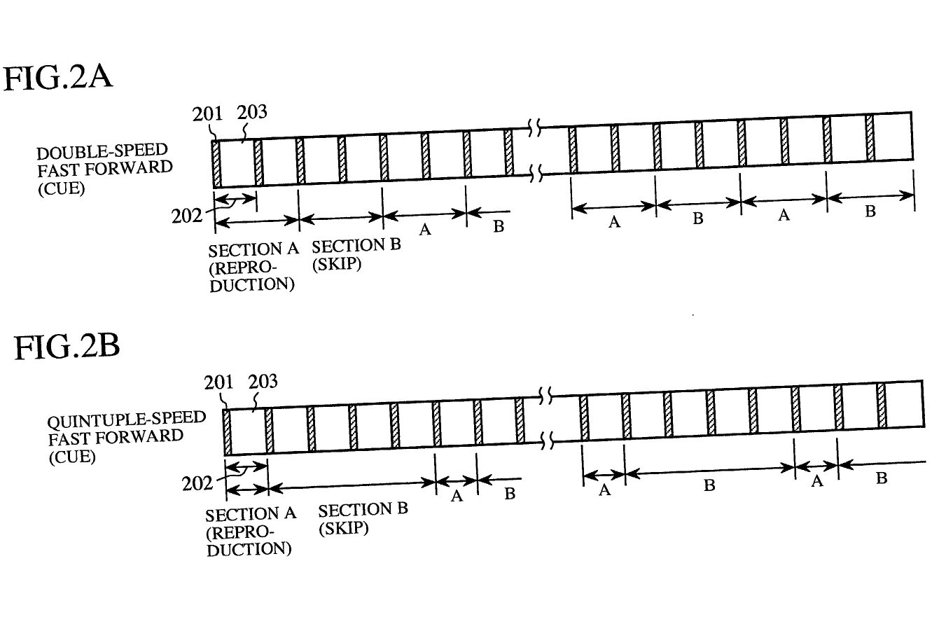

FIGS. 2A and 2B are schematic diagrams showing a frame structure of musical data for illustrating the variable-speed fast forward. In these figures, the reference numeral 201 designates a sync header, 202 designates data corresponding to one frame, and 203 designates an area including compressed musical data or the like.

FIG. 2A illustrates the double-speed fast forward, in which the reproduced frame number is two (section A), and the skipped frame number is also two (section B). In contrast, FIG. 2B illustrates the quintuple-speed fast forward, in which the reproduced frame number is one (section A), and the skipped frame number is four (section B). Such speed changes are achieved by varying the settings in the reproduced frame number setting section 11 and skipped frame number setting section 12.

As described above, the present embodiment 1 is configured such that it can vary the reproduced frame number and the skipped frame number, which are set in the reproduced frame number setting section and the skipped frame number setting section, respectively. Thus, the present embodiment 1 can vary the reproduction rate during the fast forward/reverse. As a result, it can search for and reach a desired position in a short time with ease by transporting unnecessary portions at a high speed, and a portion around a necessary section at a low speed.

### EMBODIMENT 2

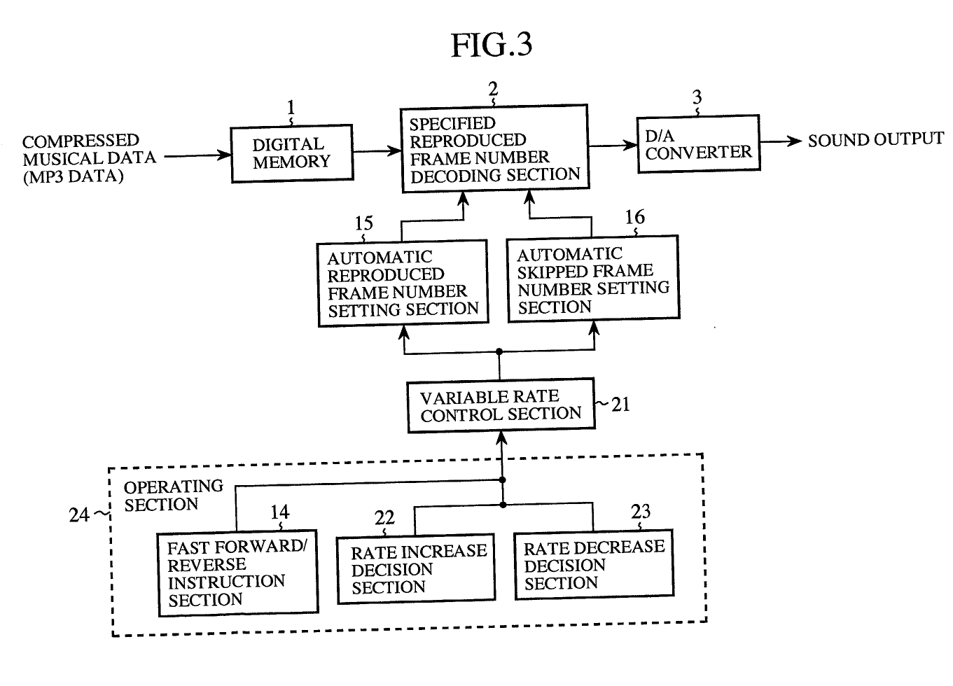

FIG. 3 is a block diagram showing a configuration of an embodiment 2 of the sound reproduction apparatus in accordance with the present invention. The present embodiment 2 is configured such that it can change the rate of the fast forward/reverse, which is described above in the embodiment 1, in response to the operating duration associated with the operating section.

In FIG. 3, the same reference numerals designate the same or like portions to those of FIG. 1, and the description thereof is omitted here. The reference numeral 15 designates an automatic reproduced frame number setting section, 16 designates an automatic skipped frame number setting section, 21 designates a variable rate control section, 22 designates a rate increase decision section, and 23 designates a rate decrease decision section. The rate increase decision section 22, the rate decrease decision section 23 and the fast forward/reverse instruction section 14 constitute an operating section 24. The rate increase decision section 22 and the rate decrease decision section 23 each comprises a key for varying the rate of the fast forward/reverse. The rate can also be varied through a key of the fast forward/reverse instruction section 14.

Next, the operation of the present embodiment 2 will be described.

When the key of the rate increase decision section 22 or that of the rate decrease decision section 23 in the operating section 24 is depressed for a long duration in the fast forward or fast reverse mode under the control of the fast forward/reverse instruction section 14, or in the normal rate reproduction mode, the long depression duration of the key is detected.

In response to the decision result of the long depression duration of the key, the variable rate control section 21 controls the automatic reproduced frame number setting section 15 and the automatic skipped frame number setting section 16, so that they automatically set the reproduced frame number and skipped frame number, respectively.

Then, according to the reproduced frame number and skipped frame number set in the automatic reproduced frame number setting section 15 and automatic skipped frame number setting section 16, the specified reproduced frame number decoding section 2 reads the audio data from the digital memory 1 by the reproduced frame number, and reproduces the audio data.

Subsequently, the specified reproduced frame number decoding section 2 skips the audio data in the digital memory 1 by the skipped frame number, followed by reading the next compressed musical data from the digital memory by the reproduced frame number. Thus, the specified reproduced frame number decoding section 2 reproduces the next audio data by the reproduced frame number.

In this way, the rate increase decision section 22 or the rate decrease decision section 23 in the operating section 24 detects the long depression duration of the key. As a result, the present embodiment 2 can implement the fast forward and fast reverse with automatically varying the reproduced frame number and the skipped frame number to desired values.

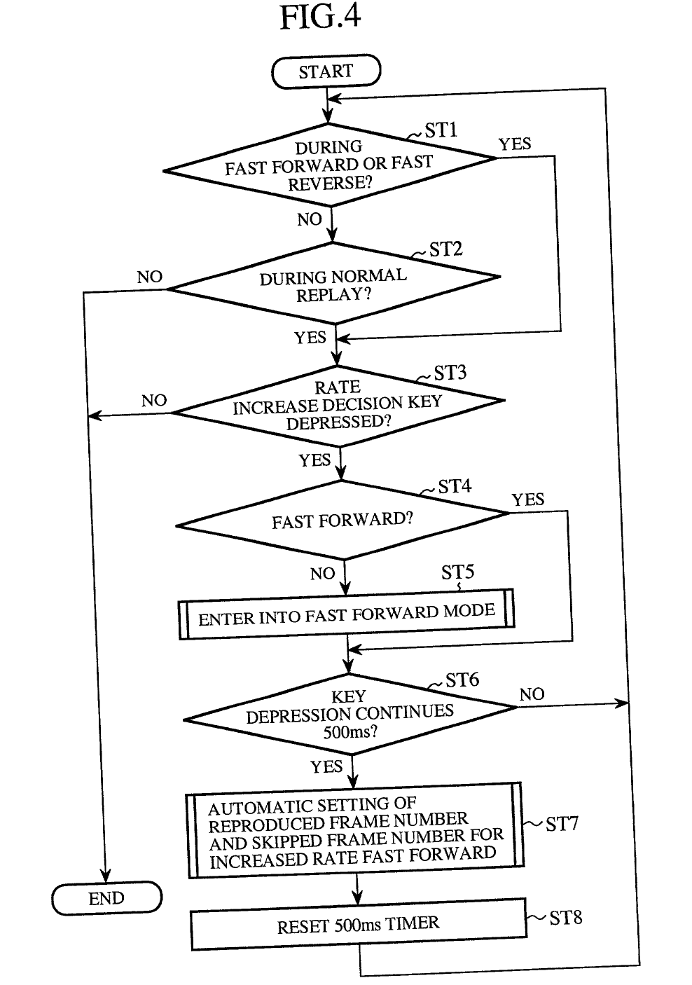

FIG. 4 is a flowchart illustrating the variable rate operation of the fast forward/reverse.

In the fast forward mode the fast forward/reverse instruction section 14 brings about (“Yes” at step ST1), or in the normal reproduction mode (“Yes” at step ST2), if the rate increase decision section 22 in the operating section 24 detects the key operation for increasing the speed (“Yes” at step ST3), and if the fast forward is not yet performed (“No” at step ST4) the fast forward/reverse instruction section 14 starts the fast forward mode (step ST5).

In addition, when the key of the fast forward/reverse instruction section 14 or that of the rate increase decision section 22 is in the long depressed state, that is, if a decision is made that the key is continuously depressed for more than a predetermined time period (500 ms, for example) (“Yes” at step ST6), the variable rate control section 21 commands the higher rate fast forward (step ST7). For example, it reduces the reproduced frame number in the automatic reproduced frame number setting section 15 from two frames to one frame. Alternatively, it increases the skipped frame number in the automatic skipped frame number setting section 16 from two frames to four frames, followed by clearing the timer (step ST8), and by returning to the initial state (step ST1). In this example, the long depression of the key in the operating section 24 enables the rate of the fast forward to be changed from the double-speed to the quintuple-speed.

In the description above, the rate increase decision section 22 brings about the high rate fast forward (quintuple-speed) by detecting the long depression of the rate increasing key. After that, when the rate decrease decision section 23 detects the long depression of the rate decreasing key, the rate of the fast forward is reduced (double speed, for example).

As described above, the present embodiment 2 is configured such that it can vary the rate of the fast forward/reverse by changing the reproduced frame number and the skipped frame number automatically by depressing the key for long duration. As a result, the present embodiment 2 offers an advantage of being able to improve the operability of the fast forward/reverse. In addition, it offers an advantage of being able to reach a desired position in a short time with ease by transporting unnecessary portions at a high speed, and a portion around a necessary section at a low speed.

### EMBODIMENT 3

The present embodiment 3 comprises a sampling frequency detecting section for detecting the sampling frequency of the compressed musical data, which is recorded in the sync header of each frame. It detects the changes of the sampling frequency during the fast forward and fast reverse, and automatically sets the reproduced frame number and the skipped frame number to predetermined values, thereby controlling the speed of the fast forward and fast reverse at values that will provide a constant perceptual feeling.

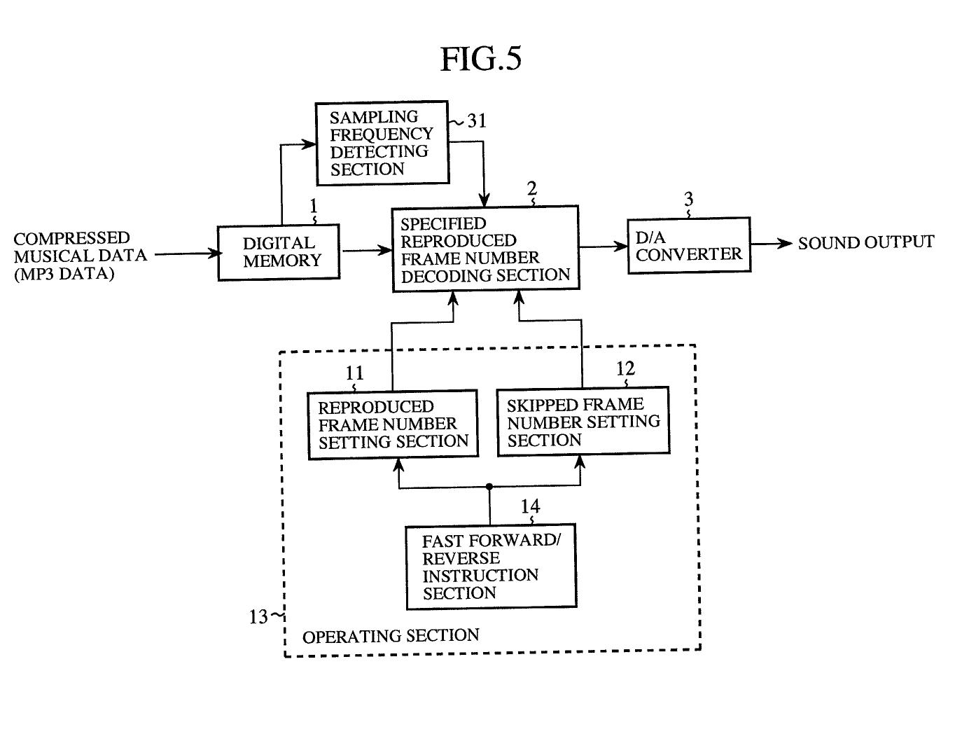

FIG. 5 is a block diagram showing a configuration of the embodiment 3 of the sound reproduction apparatus in accordance with the present invention. The configuration as shown in FIG. 5 corresponds to the configuration as described in the foregoing embodiment 1 in connection with FIG. 1 plus a sampling frequency detecting section 31. The sampling frequency detecting section 31 extracts the sampling frequency from the sync header of each frame in the digital memory 1, and supplies it to the skipped frame number setting section 12.

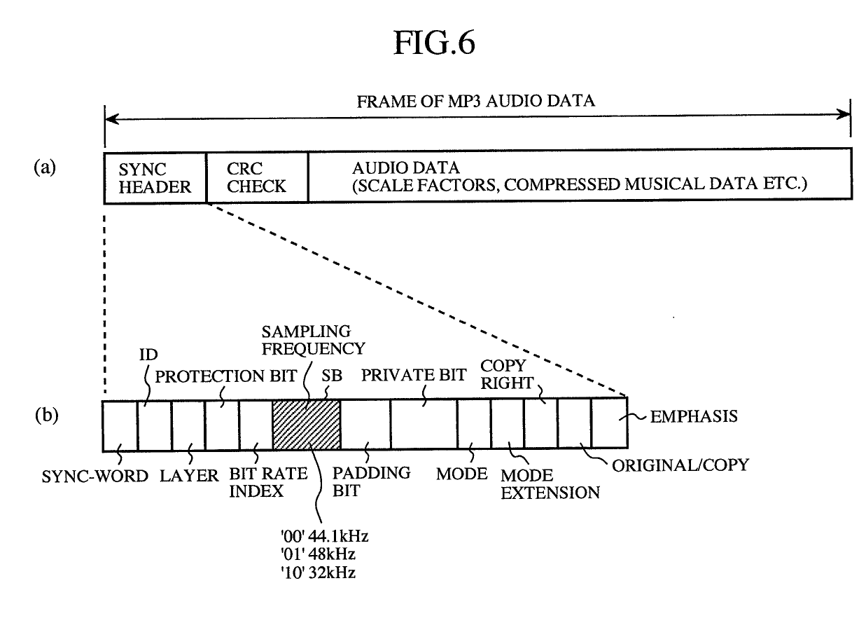

FIG. 6 is a schematic diagram showing a frame of audio data (MP3 data) . The MP3 frame includes the sync header, CRC error check and audio data (parameters such as scale factors and compressed musical data) as illustrated in FIG. 6(a).

FIG. 6(b) illustrates the sync header in detail. As shown in this figure, the sampling frequency is present in the sync header. The sampling frequency detecting section 31 detects the sampling frequency from the bits SB (two bits) indicating the sampling frequency in the sync header. For example, it recognizes that the sampling frequency is 44.1 kHz when the SB bits are “00”, 48 kHz when “01” and 32 kHz when “10”.

Next, the operation of the present embodiment 3 will be described.

As described above in the embodiment 1, when the fast forward/reverse instruction section 14 sets the fast forward or fast reverse mode, the specified reproduced frame number decoding section 2 reads the audio data from the digital memory 1 by the reproduced frame number according to the reproduced frame number and the skipped frame number in the reproduced frame number setting section 11 and the skipped frame number setting section 12. Then, the specified reproduced frame number decoding section 2 reproduces the frames by the reproduced frame number.

Subsequently, the specified reproduced frame number decoding section 2 skips the data in the digital memory 1 by the skipped frame number, followed by reading the next compressed musical data from the digital memory 1 by the reproduced frame number. Thus, the specified reproduced frame number decoding section 2 controls the fast forward or fast reverse with reproducing frames by the reproduced frame number.

When the sampling frequency detecting section 31 detects a change in the sampling frequency during the fast forward or fast reverse, it varies the setting of the reproduced frame number and skipped frame number such that the reproduction rate during the fast forward or fast reverse is maintained at a constant value before and after the change in the sampling frequency. Thus, the change in the sampling frequency during the fast forward or fast reverse does not provide any disagreeable feeling to a user.

For example, when the sampling frequency is changed to 32 kHz during the triple-speed fast forward in which the sampling frequency is 48 kHz, the reproduced frame number is six, and the skipped frame number is 12 (with keeping a constant bit rate),

One frame time at the sampling frequency 48 kHz is

1152÷48000=24 ms

and one frame time at the sampling frequency 32 kHz is

1152÷32000=36 ms

Thus, the one frame time is increased by a factor of 1.5.

Therefore, when the sampling frequency is changed to 32 kHz, the sampling frequency detecting section 31 provides the specified reproduced frame number decoding section 2 with the reproduced frame number of four and the skipped frame number of eight, that is, ⅔ (reciprocal of 1.5) of the reproduced frame number of six and the skipped frame number of 12 of the previous triple-speed fast forward or fast reverse, thereby implementing the triple-speed fast forward that will provide equal perceptual feeling.

Although the sampling frequency detecting section 31 provides the specified reproduced frame number decoding section 2 with the changed reproduced frame number and skipped frame number directly in accordance with the change in the sampling frequency in the foregoing description, this is not essential. For example, it can change the reproduced frame number and skipped frame number that are set in the reproduced frame number setting section 11 and skipped frame number setting section 12.

As described above, the present embodiment 3 offers an advantage of being able to keep the perceptual speed constant before and after the change, thereby making it possible to avoid a disagreeable perceptual feeling even when the sampling frequency of the audio data varies during the fast forward/reverse.

### EMBODIMENT 4

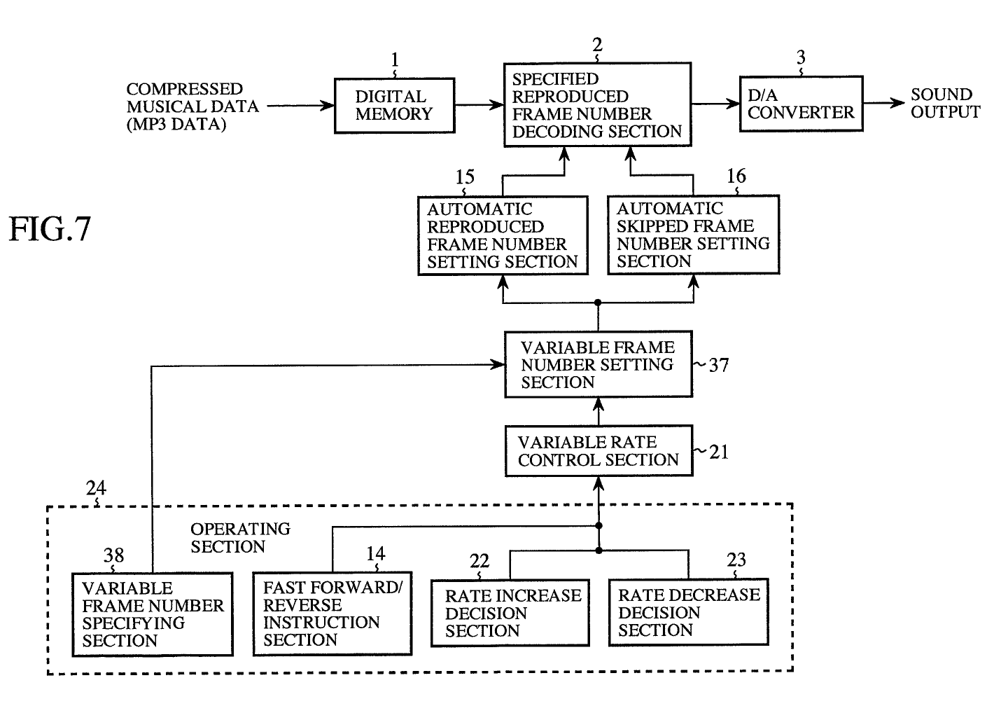

FIG. 7 is a block diagram showing a configuration of an embodiment 4 of the sound reproduction apparatus in accordance with the present invention. The configuration as shown in this figure corresponds to the configuration as described in the foregoing embodiment 2 in connection with FIG. 3 plus a setting means for enabling the reproduced frames or the skipped frames to be set individually.

In FIG. 7, the reference numeral 37 designates a variable frame number setting section, and 38 designates a variable frame number specifying section.

The variable frame number setting section 37 is installed between the variable rate control section 21 and the automatic reproduced frame number setting section 15 and automatic skipped frame number setting section 16. It can variably set only the reproduced frame number, or only the skipped frame number, or both the reproduced frame number and skipped frame number.

The variable frame number specifying section 38 is installed in the operating section 24, and provides the variable frame number setting section 37 with the instruction to change only the reproduced frame number, or only the skipped frame number, or both the reproduced frame number and skipped frame number.

Next, the operation of the present embodiment 4 will be described.

When the key of the rate increase decision section 22 or that of the rate decrease decision section 23 in the operating section 24 is depressed for a long duration in the fast forward or fast reverse mode under the control of the fast forward/reverse instruction section 14, or in the normal rate reproduction mode, the long depression duration of the key is detected. In response to the decision result of the long depression duration of the key, the variable rate control section 21 controls the automatic reproduced frame number setting section 15 and the automatic skipped frame number setting section 16, so that they automatically set the reproduced frame number and skipped frame number, respectively.

Then, according to the reproduced frame number and skipped frame number set in the automatic reproduced frame number setting section 15 and automatic skipped frame number setting section 16, the specified reproduced frame number decoding section 2 reads the audio data from the digital memory 1 by the reproduced frame number, and reproduces the audio data.

Subsequently, the specified reproduced frame number decoding section 2 skips the audio data in the digital memory 1 by the skipped frame number, followed by reading the next compressed musical data from the digital memory by the reproduced frame number. Thus, the specified reproduced frame number decoding section 2 reproduces the next audio data by the reproduced frame number.

In this way, the rate increase decision section 22 or the rate decrease decision section 23 in the operating section 24 detects the long depression duration of the key. As a result, the present embodiment 4 can implement the fast forward and fast reverse with automatically varying the reproduced frame number and the skipped frame number to desired values.

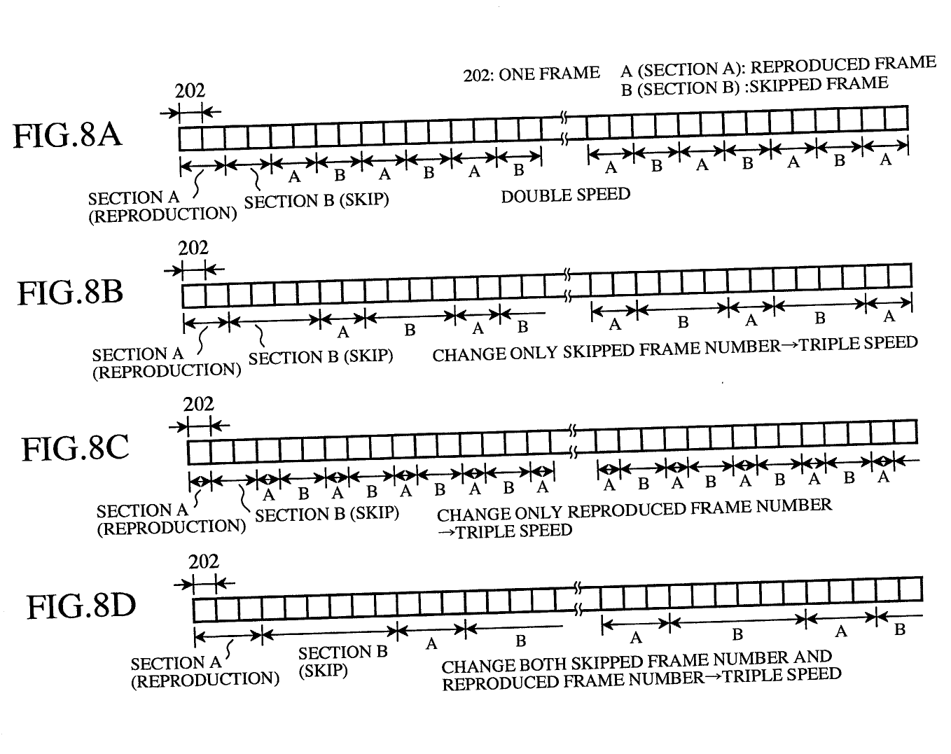

FIGS. 8A-8D are schematic diagrams showing frame structures for explaining the operation of changing the reproduced and skipped frames. Referring to these figures, the setting change operation will be described of only the reproduced frame number, or only the skipped frame number or both the reproduced frame number and skipped frame number during the fast forward/reverse operation.

FIG. 8A illustrate a double-speed fast forward operation, in which the reproduced frame number is two (section A), and the skipped frame number is also two (section B).

In this state, the variable frame number specifying section 38 changes only the skipped frame number to enable the triple-speed fast forward as illustrated in FIG. 8B.

When the variable frame number specifying section 38 specifies the triple-speed, the variable frame number setting section 37 changes the skipped frame number to be set to the automatic skipped frame number setting section 16 to four with maintaining the reproduced frame number at two. Thus, the triple-speed fast forward is achieved.

FIG. 8C illustrates the case where the variable frame number specifying section 38 changes only the reproduced frame number in the double-speed fast forward as illustrated in FIG. 8A to achieve the triple-speed fast forward.

When the variable frame number specifying section 38 specifies the triple-speed, the variable frame number setting section 37 changes the reproduced frame number to be set to the automatic reproduced frame number setting section 15 to one with maintaining the skipped frame number at two. Thus, the triple-speed fast forward is implemented.

FIG. 8D illustrates the case where the variable frame number specifying section 38 changes both the reproduced frame number and skipped frame number in the double-speed state as shown in FIG. 8A to achieve the triple-speed fast forward.

When the variable frame number specifying section 38 specifies the triple-speed, the variable frame number setting section 37 changes the reproduced frame number to three and the skipped frame number to six, and sets them to the automatic reproduced frame number setting section 15 and the automatic skipped frame number setting section 16, respectively. Thus, the triple-speed fast forward is implemented.

As described above, the present embodiment 4 is configured such that it can vary the speed of the fast forward/reverse by changing the reproduced frame number and the skipped frame number, which are set in the reproduced frame number setting section and the skipped frame number setting section, respectively. Accordingly, the present embodiment 4 can transport unnecessary portions at a high speed, and reduces the speed around the necessary section, thereby offering an advantage of being able to reach a desired position in a short time with ease. In addition, it is configured such that it can change the reproduced frame number and skipped frame number individually or in combination during the fast forward/reverse to vary the speed. Therefore, it can change the ratio between the reproduced frame number and the skipped frame number, and the number of consecutive frames to be reproduced or skipped. As a result, the present embodiment 4 can set appropriate frame numbers to achieve the perceptually comfortable reproduction of the audio data, offering an advantage of being able to improve the operability of the fast forward/reverse.

In the foregoing embodiments, although the description is made only about the fast forward (CUE), the fast reverse (REVIEW) can also be achieved by setting the reproduced frames and skipped frames, and by varying their numbers. Thus, the fast reverse corresponding to the changed values can be implemented.

What is claimed is:

1. A sound reproduction apparatus for reproducing audio data consisting of a plurality of frames, said sound reproduction apparatus comprising:
an operating section for detecting a key operation for fast forward/reverse and issues an instruction of the fast forward/reverse;
a specified reproduced frame number decoding section for decoding a specified reproduced frame number of frames and for skipping a specified skipped frame number of frames in the audio data during the fast forward/reverse;
a reproduced frame number setting section for providing said specified reproduced frame number decoding section with the specified reproduced frame number for the fast forward/reverse; and
a skipped frame number setting section for providing said specified reproduced frame number decoding section with the specified skipped frame number for the fast forward/reverse.

2. The sound reproduction apparatus according to claim 1, further comprising a rate change decision section for detecting depression duration of a key of said operating section, and for increasing a rate of the fast forward/reverse by varying at least one of the specified reproduced frame number in said reproduced frame number setting section and the specified skipped frame number in said skipped frame number setting section to values that will accelerate the fast forward/reverse.

3. The sound reproduction apparatus according to claim 1, further comprising a sampling frequency detecting section for detecting a sampling frequency of the audio data in a sync header included in each frame of the audio data, and for varying, when the sampling frequency is changed during the fast forward/reverse, at least one of the specified reproduced frame number and the specified skipped frame number to a predetermined value in response to the sampling frequencies before and after the change of the sampling frequency.

4. The sound reproduction apparatus according to claim 2, further comprising a variable frame number specifying section for varying the specified reproduced frame number to be set in said reproduced frame number setting section and the specified skipped frame number to be set in said skipped frame number setting section for the fast forward/reverse individually or in combination, when depression duration of a key in said operating section is longer than normal duration to further increase the speed of the fast forward/reverse.

5. The sound reproduction apparatus according to claim 2, further comprising a sampling frequency detecting section for detecting a sampling frequency of the audio data in a sync header included in each frame of the audio data, and for varying, when the sampling frequency is changed during the fast forward/reverse, at least one of the specified reproduced frame number and the specified skipped frame number to a predetermined value in response to the sampling frequencies before and after the change of the sampling frequency.

6. The sound reproduction apparatus according to claim 5, further comprising a variable frame number specifying section for varying the specified reproduced frame number to be set in said reproduced frame number setting section and the specified skipped frame number to be set in said skipped frame number setting section for the fast forward/reverse individually or in combination, when depression duration of a key in said operating section is longer than normal duration to further increase the speed of the fast forward/reverse.

7. A sound reproduction method of reproducing audio data consisting of a plurality of frames, said sound reproduction method comprising the steps of:
detecting a key operation for fast forward/reverse;
decoding a specified reproduced frame number of frames and skipping a specified skipped number of frames; and
changing at least one of the specified reproduced frame number and the specified skipped frame number to desired values for the fast forward/reverse.

8. The sound reproduction method according to claim 7, further comprising the steps of:
detecting depression duration of a key for the fast forward/reverse; and
increasing a rate of the fast forward/reverse by varying at least one of the specified reproduced frame number and the specified skipped frame number to a value that will accelerate the fast forward/reverse.

9. The sound reproduction method according to claim 7, further comprising the steps of:
detecting a sampling frequency of the audio data in a sync header included in each frame of the audio data; and
varying, when the sampling frequency is changed during the fast forward/reverse, at least one of the specified reproduced frame number and the specified skipped frame number to a predetermined value in response to the sampling frequencies before and after the change of the sampling frequency.

10. The sound reproduction method according to claim 8, further comprising the step of varying, when depression duration of a key in an operating section is longer than normal duration in the fast forward/reverse mode, the specified reproduced frame number and the specified skipped frame number individually or in combination to such values that will increase the rate of the fast forward/reverse.

11. The sound reproduction method according to claim 8, further comprising the steps of:
detecting a sampling frequency of the audio data in a sync header included in each frame of the audio data; and
varying, when the sampling frequency is changed during the fast forward/reverse, at least one of the specified reproduced frame number and the specified skipped frame number to a predetermined value in response to the sampling frequencies before and after the change of the sampling frequency.

12. The sound reproduction method according to claim 11, further comprising the step of varying, when depression duration of a key in an operating section is longer than normal duration in the fast forward/reverse mode, the specified reproduced frame number and the specified skipped frame number individually or in combination to such values that will increase the rate of the fast forward/reverse.
